(19) United States
(12) Patent Application Publication
(10) Pub. No.: US 2015/0085185 A1
(43) Pub. Date: Mar. 26, 2015

(54) MOUNTING STRUCTURE FOR CAMERA AND PORTABLE ELECTRONIC DEVICE USING SAME

(71) Applicants: FIH (Hong Kong) Limited, Kowloon (HK); SHENZHEN FUTAIHONG PRECISION INDUSTRY CO., LTD., Shenzhen (CN)

(72) Inventor: ZHENG-PING TAN, Shenzhen (CN)

(73) Assignees: FIH (HONG KONG) LIMITED, Kowloon (HK); SHENZHEN FUTAIHONG PRECISION INDUSTRY CO., LTD., Shenzhen (CN)

(21) Appl. No.: 14/092,952

(22) Filed: Nov. 28, 2013

(30) Foreign Application Priority Data
Sep. 25, 2013 (CN) 2013104394347

(51) Int. Cl. H04N 5/225

(52) U.S. Cl. CPC H04N 5/2253
USPC 348/376; 348/373

(57) ABSTRACT

A mounting structure for a camera includes a main plate, a support plate assembly and a stopper assembly. The camera includes at least two edges. The support plate assembly extends from a side of the main plate, and the stopper assembly extends from an opposite side of the main plate. The main plate supports the camera and the stopper assembly is located adjacent the at least two edges of the camera.

### BACKGROUND

1. Technical Field

The present disclosure relates to mounting structures for cameras, and more particularly to a mounting structure for camera used in a portable electronic device.

2. Description of Related Art

Generally, a camera of a typical portable electronic device, such as a mobile phone, is welded onto a printed circuit board of the portable electronic device. However, due to limited space inside the portable electronic device, if there is a large space between the printed circuit board and a housing of the portable electronic device, a distance between the camera and the housing is too long to satisfy imaging conditions of the camera.

Therefore, there is room for improvement within the art.

### BRIEF DESCRIPTION OF THE DRAWINGS

Many aspects of the present mounting structure for camera and portable electronic device using same can be better understood with reference to the following drawings. The components in the various drawings are not necessarily drawn to scale, the emphasis instead being placed upon clearly illustrating the principles of the present mounting structure for camera and portable electronic device using same.

FIG. 1 is a schematic view of a mounting structure for camera used in a portable electronic device, according to an exemplary embodiment.

FIG. 2 is an exploded view of the portable electronic device shown in FIG. 1.

FIG. 3 is similar to FIG. 2, but shown from another angle.

FIG. 4 is an enlarged view of the mounting structure for camera shown in FIG. 1.

### DETAILED DESCRIPTION

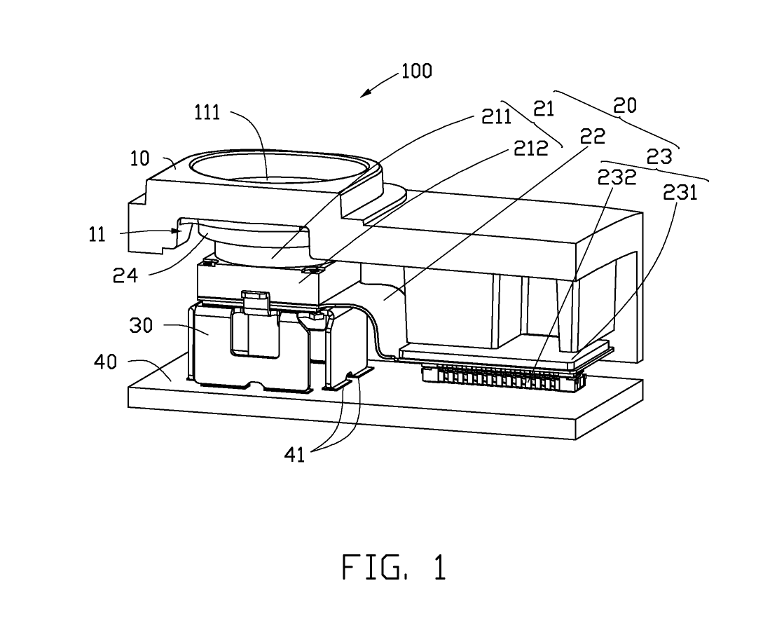

FIG. 1 shows a portion of a portable electronic device 100, such as a mobile phone, personal digital assistant or laptop. The portable electronic device 100 includes a housing 10, a camera assembly 20, a mounting structure 30, and a circuit board 40. The camera assembly 20 is mounted on the mounting structure 30, and the mounting structure 30 is fixed on the circuit board 40. The camera assembly 20, the mounting structure 30 and the circuit board 40 are received in the housing 10.

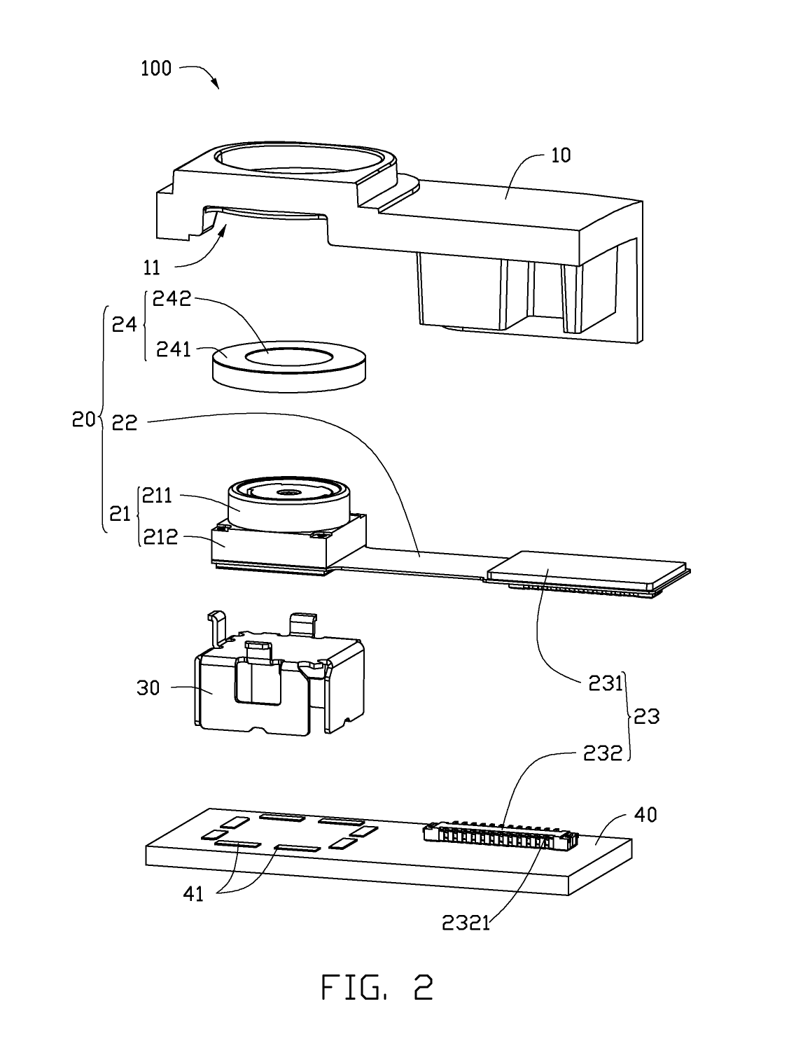

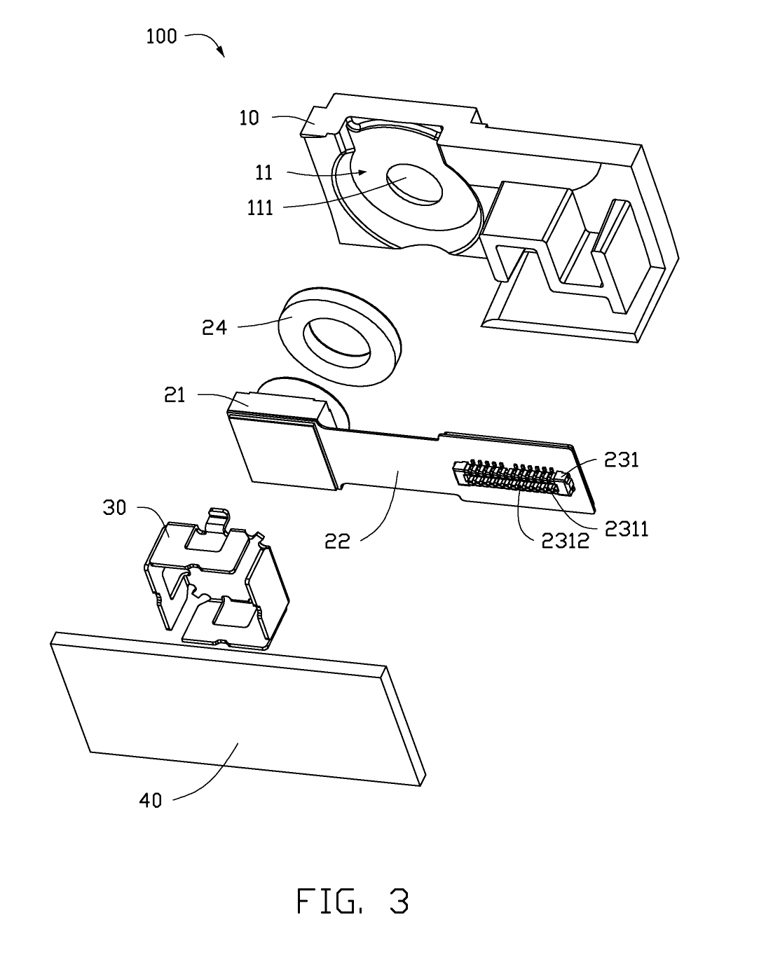

FIG. 2 and FIG. 3 are exploded views of the portable electronic device 100. An inner surface of the housing 10 defines a receiving groove 11, and a bottom wall of the receiving groove 11 defines an aperture 111.

The camera assembly 20 includes a camera 21, a flexible printed circuit (FPC) 22, a connector assembly 23, and a sealing element 24. The camera 21 is electronically connected to the connector assembly 23 by the FPC 22. The camera 21 includes a main body 211 and a positioning block 212. The main body 211 is located on the positioning block 212. The positioning block 212 has at least two edges. The connector assembly 23 includes a first connector 231 and a second connector 232. The first connector 231 is electronically connected to the FPC 22. The first connector 231 defines an engaging groove 2311, and a plurality of connection pins 2312 are located on two sidewalls of the engaging groove 2311. The second connector 232 is located on the circuit board 40. The second connector 232 includes a plurality of electrical contacts 2321.

In this embodiment, the sealing element 24 is made of foam. The sealing element 24 defines a through hole 242 corresponding to the aperture 111. An adhesive 241 covers a surface of the sealing element 24.

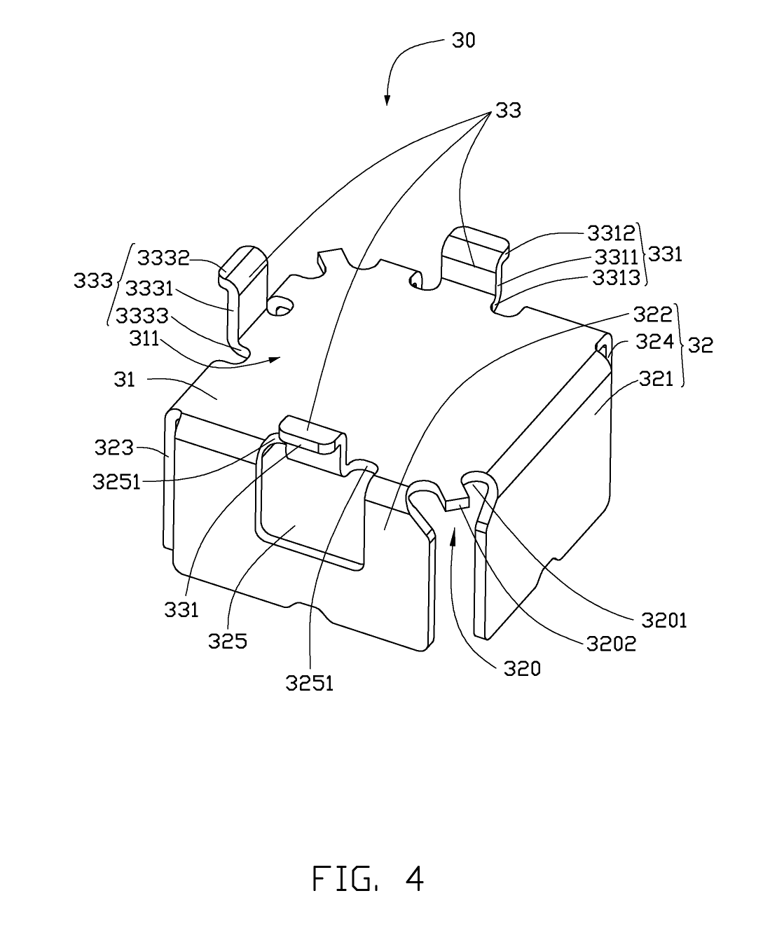

FIG. 4 is an enlarged view of the mounting structure 30. The mounting structure 30 includes a main plate 31, a support plate assembly 32, and a stopper assembly 33. The main plate 31 corresponds to the positioning block 212. The main plate 31 includes a mounting surface 311. The support plate assembly 32 includes a first support plate 321, a second support plate 322, a third support plate 323, and a fourth support plate 324 respectively extending from four edges of the main plate 31. The first support plate 321, the second support plate 322, the third support plate 323, and the fourth support plate 324 are located at one side of the main plate 31 opposite to the mounting surface 311 and are perpendicularly connected to the main plate 31.

The first support plate 321 is opposite and parallel to the third support plate 323. The second support plate 322 is opposite and parallel to the fourth support plate 324. The first support plate 321, the second support plate 322, and the main plate 31 cooperatively define a notch 320, and the third support plate 323, the fourth support plate 324 and the main plate 31 also cooperatively define another notch 320. Each notch 320 is substantially heart-shaped and includes a connecting wall 3201 belonging to the main plate 31. A protrusion 3202 protrudes from the connecting wall 3201. Each of the second support plate 322, the third support plate 323, and the fourth support plate 324 defines an opening 325 extending to the main plate 31. The opening 325 is substantially rectangular and includes two arcuate inner walls 3251. The two inner walls 3251 are spaced apart from each other and are located at the main plate 31.

The stopper assembly 33 is perpendicularly connected to the main plate 31, and is opposite to the support plate assembly 32. The stopper assembly 33 includes two first stoppers 331 and a second stopper 333. One first stopper 331 is located between the two inner walls 3251 of the second support plate 322, and the other first stopper 331 is located between the two inner walls 3251 of the fourth support plate 324. The second stopper 333 is located between the two inner walls 3251 of the third support plate 323. Each first stopper 331 is substantially Z-shaped and includes a first base 3311, a first end portion 3312, and a first connecting portion 3313. The first end portion 3312 extends from one end of the first base 3311, and the first connecting portion 3313 extends from the other end of the first base 3311 in opposite direction of the first end portion 3312. The first connecting portion 3313 connects to the main plate 31. The second stopper 333 is substantially Z-shaped and includes a second base 3331, a second end portion 3332, and a second connecting portion 3333. The second end portion 3332 extends from one end of the second base 3331, and the second connecting portion 3333 extends from the other end of the second base 3331 in opposite direction of the second end portion 3332. The second connecting portion 3333 connects to the main plate 31. The second base 3331 is higher than the first base 3311.

In this embodiment, the mounting structure 30 is made of titanium alloy, and is made by stamping. During the stamping process, one mounting structure 30 connects to another mounting structure 30 by the protrusion 3202.

In assembly of the portable electronic device 100, an adhesive layer (not shown) is attached to the mounting surface 311, and in this embodiment, the adhesive layer is double-sided adhesive tape. The positioning block 212 of the camera 21 is aligned with the mounting surface 311 and moves toward to the mounting surface 311 until the positioning block 212 resists against the second base 3331 of the second stopper 333. The positioning block 212 moves toward to the mounting surface 311 along the second base 3331, and the positioning block 212 fits tightly with the adhesive layer. Then, the camera 21 is fixed on the mounting structure 30. The stopper assembly 33 is located adjacent to the edges of the positioning block 212 to prevent the positioning block 212 from shaking

A free end of the first support plate 321, a free end of the second support plate 322, a free end of the third support plate 323 and a free end of the fourth support plate 324 are fixed on the circuit board 40 with another adhesive layer 41 (shown in FIG. 2) attached to circuit board 40. The second connector 232 is received in the engaging groove 2311 of the first connector 231, and the plurality of electrical contacts 2321 are electronically connected to the plurality of connection pins 2312. The sealing element 24 is received in the receiving groove 11 of the housing 10. The adhesive 241 fits closely with the bottom wall of the receiving groove 11 and is aligned with the aperture 111. The housing 10 covers the camera 21, and the sealing element 24 resists between the housing 10 and the main body 211 of the camera 21.

The mounting structure 30 with a simple structure is easy to assemble. The mounting structure 30 can decrease a distance between the camera 21 and the housing 10 to satisfy imaging conditions of the camera 21.

In another exemplary embodiment, one or two of the first support plate 321, the second support plate 322, the third support plate 323 and the fourth support plate 324 can be omitted.

In another exemplary embodiment, the circuit board 40 may define a plurality of latching grooves to engage with the support plate assembly 32.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A mounting structure for a camera having at least two edges, comprising:
a main plate;
a support plate assembly; and
a stopper assembly;
wherein the support plate assembly extends from a side of the main plate, the stopper assembly extends from an opposite side of the main plate; and the main plate supports the camera and the stopper assembly is located adjacent the at least two edges of the camera.

2. The mounting structure as claimed in claim 1, wherein the stopper assembly comprises two opposite first stoppers and a second stopper; each first stopper comprises a first base, a first end portion, and a first connecting portion; the first end portion extends from one end of the first base, and the first connecting portion extends from the other end of the first base in opposite direction of the first end portion, the first connecting portion connects to the main plate; the second stopper comprises a second base, a second end portion, and a second connecting portion; the second end portion extends from one end of the second base, and the second connecting portion extends from the other end of the second base in opposite direction of the second end portion, the second connecting portion connects to the main plate.

3. The mounting structure as claimed in claim 2, wherein the second base is higher than the first base.

4. The mounting structure as claimed in claim 2, wherein the support plate assembly comprises a first support plate, a second support plate, a third support plate and a fourth support plate; the first support plate is opposite and parallel to the third support plate; the second support plate is opposite and parallel to the fourth support plate.

5. The mounting structure as claimed in claim 4, wherein each of the second support plate, the third support plate and the fourth support plate defines an opening 325 extending to the main plate; the opening comprises two arcuate inner walls, the inner walls are spaced apart from each other are located at the main plate.

6. The mounting structure as claimed in claim 5, wherein one first stopper is located between the two inner walls of the second support plate, and the other first stopper is located between the two inner walls of the fourth support plate, the second stopper is located between the two inner walls of the third support plate.

7. The mounting structure as claimed in claim 6, wherein the first support plate, the second support plate, and the main plate cooperatively define a notch, and the third support plate, the fourth support plate and the main plate also cooperatively define a notch; each notch comprises a connecting wall, and a protrusion protrudes from the connecting wall.

8. The mounting structure as claimed in claim 1, wherein the mounting structure is made of titanium alloy, and is made by stamping.

9. A portable electronic device, comprising:
a circuit board;
a mounting structure mounted on the circuit board, the mounting structure comprising a main plate, a support plate, and a stopper assembly; and
a camera assembly mounted on the mounting structure, the camera assembly comprising a camera having at least two edges;
wherein the support plate assembly is located on the circuit board and a stopper assembly is configured for preventing the camera from shaking; the support plate assembly extends from a side of the main plate, the stopper assembly extends from an opposite side of the main plate; and the main plate supports the camera and the stopper assembly is located adjacent the at least two edges of the camera.

10. The portable electronic device as claimed in claim 9, wherein the stopper assembly comprises two opposite first stoppers and a second stopper; each first stopper comprises a first base, a first end portion, and a first connecting portion; the first end portion extends from one end of the first base, and the first connecting portion extends from the other end of the first base in opposite direction of the first end portion, the first connecting portion connects to the main plate; the second stopper comprises a second base, a second end portion, and a second connecting portion; the second end portion extends from one end of the second base, and the second connecting portion extends from the other end of the second base in opposite direction of the second end portion, the second connecting portion connects to the main plate.

11. The portable electronic device as claimed in claim 10, wherein the second base is higher than the first base.

12. The portable electronic device as claimed in claim 10, wherein the support plate assembly comprises a first support plate, a second support plate, a third support plate and a fourth support plate; the first support plate is opposite and parallel to the third support plate; the second support plate is opposite and parallel to the fourth support plate.

13. The portable electronic device as claimed in claim 12, wherein each of the second support plate, the third support plate and the fourth support plate defines an opening 325 extending to the main plate; the opening comprises two arcuate inner walls, the inner walls are spaced apart from each other are located at the main plate.

14. The portable electronic device as claimed in claim 13, wherein the first support plate, the second support plate, and the main plate cooperatively define a notch, and the third support plate, the fourth support plate and the main plate also cooperatively define a notch; each notch comprises a connecting wall, and a protrusion protrudes from the connecting wall.

15. The portable electronic device as claimed in claim 14, wherein the camera comprises a main body and a positioning block, the main body is located on the positioning block; the positioning block is located on the main plate.

16. The portable electronic device as claimed in claim 15, wherein the camera assembly further comprises a flexible printed circuit (FPC), a connector assembly; the camera is electronically connected to the connector assembly by the FPC.

17. The portable electronic device as claimed in claim 15, further comprises a housing defining a receiving groove; wherein the camera assembly further comprises a sealing element; the sealing element is received in the receiving groove and resists between the housing and the main body of the camera.

18. The portable electronic device as claimed in claim 17, wherein a bottom wall of the receiving groove defines an aperture; the sealing element defines a through hole aligned with the aperture.

19. The portable electronic device as claimed in claim 9, wherein the mounting structure is made of titanium alloy, and is made by stamping.
